(19) United States
(12) Patent Application Publication
(10) Pub. No.: US 2002/0054086 A1
(43) Pub. Date: May 9, 2002

(54) Method and apparatus for adapting a graphical user interface

(76) Inventors: Robert Leslie Van Oostenbrugge, Eindhoven (NL); Paulus George Maria De Bot, Eindhoven (NL); Astrid Mathilda Ferdinanda Dobbelaar, Eindhoven (NL)

Correspondence Address: Corporate Patent Counsel, U.S. Philips Corporation, 580 White Plains Road, Tarrytown, NY, 10591, US

(21) Appl. No.: 09/832,719

(22) Filed: Apr. 11, 2001

(30) Foreign Application Priority Data
Apr. 19, 2000 (EP) 00201410.8

(51) Int. Cl. G09G 5/00

(52) U.S. Cl. 345/744

(57) ABSTRACT

The invention relates to a method and apparatus for adapting a graphical user interface. A skin is applied to the graphical user interface so as to influence its look and feel, in response to an event which does not originate from a user request to change the currently applied skin. Such an event may be a change of a category of presented information, a command received from a remote server, or a change of a user profile. Skins thus change dynamically without requiring an explicit user request.

### FIELD OF THE INVENTION

The invention relates to an apparatus comprising presentation means for presenting a graphical user interface and skin means for applying a skin to the graphical user interface so as to influence the look of the graphical user interface.

The invention further relates to a method of transmitting information to the above apparatus, and to a computer program product.

### BACKGROUND OF THE INVENTION

Skins are known from certain audio player software products, such as the WinAmp™ audio player. A computing device executing such an audio player program constitutes an apparatus which enables the user to change the default graphical user interface by means of a specific skin. A skin may consist of a user interface layout, which defines a specific background, colors and shapes, and the position and nature of control buttons in the graphical user interface. In this way, the audio player may adopt the look of, for example, a classic Wurlitzer™ jukebox.

Skins can be downloaded from the internet and stored locally. The audio player software provides a user control option for reading a stored skin and applying it to the graphical user interface. In this way the user can select the look of the audio player which optimally suits his taste and mood.

A disadvantage of the known product is that the user has to perform many actions to achieve the desired result. He has to locate skins on a web server, select one and download it to his personal computer, and then apply it to the graphical user interface of the audio player. If the selected skin is not satisfactory, the whole procedure has to be repeated.

### OBJECT AND SUMMARY OF THE INVENTION

It is an object of the invention to provide an improved and more attractive apparatus and method of the type defined in the opening paragraphs. To that end, the apparatus according to the invention is characterized in that the skin means are adapted to change a currently applied skin in response to an event not originating from a user request to change the currently applied skin. In this way it is achieved that the user need not enter explicit commands to change the currently applied skin. The apparatus according to the invention is capable of initiating a skin change without an explicit user request. Said event may be random generated or dependent on internal or external factors influencing the internal state of the apparatus. As a result, the user need only concentrate on the main activity, e.g. listening to music, and can still enjoy the regular change of the look of the graphical user interface. The skin changes are automatically performed by the apparatus. Hence, a more attractive apparatus is obtained.

An embodiment of the apparatus according to the invention is characterized in that the apparatus further comprises receiving means for receiving information from a remote server, said event comprising the reception of a skin change command from the remote server. In this way it is achieved that a change of the applied skin can be initiated from a remote server. For example, an apparatus or computer program product may be used or purchased for a low price on condition that the remote server may transmit at regular intervals skins comprising sponsor messages and advertisements, which are then automatically applied to the graphical user interface of the apparatus or computer program product.

An embodiment of the apparatus according to the invention is characterized in that the apparatus further comprises storage means for storing a plurality of skins, the skin change command including an identification of a respective one of the plurality of skins, the skin means being adapted to apply said respective skin to the graphical user interface in response to said skin change command. In this way it is achieved that the remote server need only transmit an identification of a skin already stored locally in the apparatus according to the invention. Hence, there is no need to transmit a full skin description, i.e. bitmaps, colors, screen coordinates etc., which is advantageous in view of bandwidth and computing capacity.

An embodiment of the apparatus according to the invention is characterized in that the presentation means are capable of presenting further information, the event comprising a change of a parameter of said further information. The applied skin is thus influenced by some parameter of information, which enhances the attractiveness and persuasive force of the presented information.

An embodiment of the apparatus according to the invention is characterized in that said further information comprises audio and/or video content, said parameter representing a category of said content. The audio and/or video content may be stored locally, e.g. on tape, hard disk or optical disks, or received from a remote server, such as a broadcaster or website. Such content, in particular music and video programs, is liable to affect the mood of the listener or viewer. Hence, a graphical user interface which continuously and automatically adapts to the currently presented content, for example in dependence on the related category or genre, is highly attractive. A broadcaster of such content may transmit, along with the transmitted content, suitable skins which reflect the content's category, or which relate to other parameters such as actor, composer, performer etc. Alternatively, only a code corresponding to a category or other parameter may be transmitted to the apparatus, causing the apparatus to select a locally stored skin and apply that skin to the graphical user interface. Locally stored content, such as MP3 files or video programs stored on tape or on hard disk, may also be associated with a code corresponding to the content's category, performer etc. When such content is played, the associated code is interpreted and a suitable skin is read from local storage, or downloaded from a remote server, and applied to the graphical user interface.

An embodiment of the apparatus according to the invention is characterized in that the apparatus further comprises user profile means for maintaining a user profile, said event comprising a change of said user profile. It is known per se to maintain a user profile which automatically adapts to the user's behavior, by monitoring the user's selection of content, measuring viewing or listening times etc. Such user profiles are then used to advise the user about broadcast content which he is likely to appreciate. The present embodiment of the apparatus according to the invention is adapted to change the skin applied to the graphical user interface in response to such a change of the user profile. For example, if the user regularly watches sports programs, skins may be selected comprising impressions of various sports, possibly the user's favorite ones, or include colors associated with national teams, etc. Instead of selecting a completely different skin, only one or more aspects of a skin, e.g. color and/or brightness, may be changed in response to a change of the user profile.

The invention is particularly suitable for apparatuses playing audio and/or video content, either stored locally or received from a remote server or broadcaster. The invention may further be applied to any device comprising a display screen or means for presenting information on a separate display screen. For example, the invention may be applied to mobile phones, remote controls, computers, MP3 players etc.

### BRIEF DESCRIPTION OF THE DRAWINGS

These and other aspects of the invention are apparent from and will be elucidated, by way of non-limitative example, with reference to the embodiment(s) described hereinafter. In the drawings,

FIG. 1 shows a diagram of an embodiment of the apparatus according to the invention which takes the form of a personal computer, connected to a remote server via a network,

FIG. 2 shows a block diagram of an embodiment of the apparatus according to the invention which takes the form of a digital television receiver,

FIG. 3 shows a flow-chart of a simple method of distributing audio and/or video content according to the invention.

### DESCRIPTION OF EMBODIMENTS

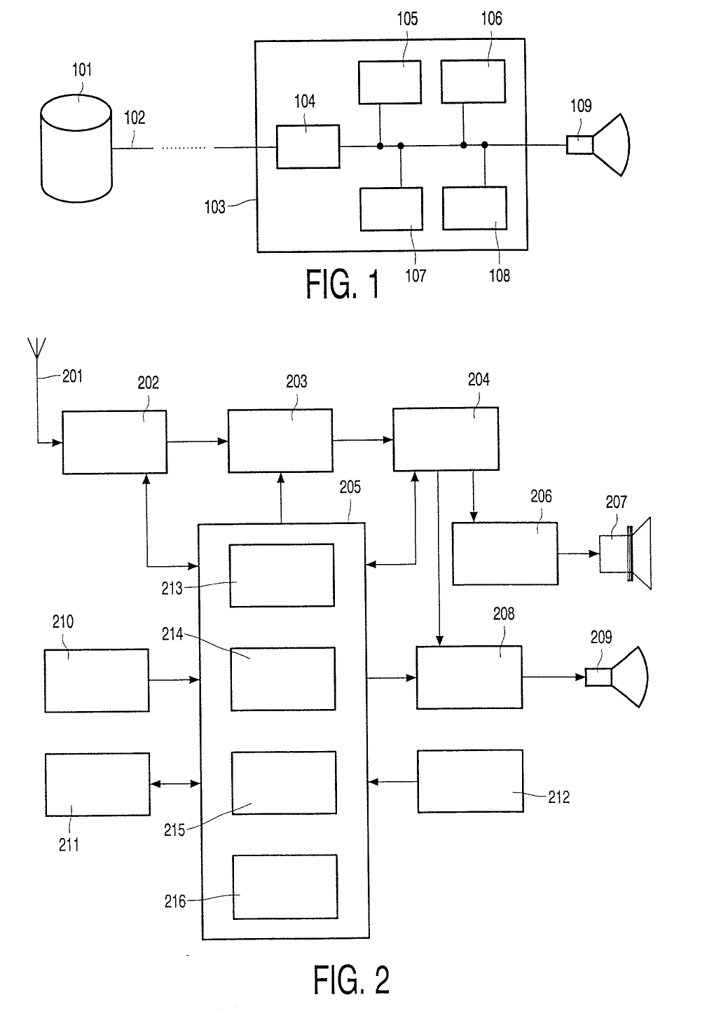

FIG. 1 shows a diagram of an embodiment of the apparatus according to the invention which takes the form of a personal computer 103, connected to a remote server 101 via a network, for example the internet, 102. The personal computer 103 includes a modem 104 for communication with the remote server 101 via the network 102. The personal computer 103 further has a central processing unit (CPU) 105 and local storage means 106. The CPU 105 is capable of executing computer program products stored in the local storage 106. The program products may be downloaded via the network 102 or loaded from a data carrier such as a CD-ROM by means of a CD-ROM player (not shown). The local storage 106 may further be used to store temporary information needed for properly executing a computer program product. The personal computer 103 further has user control means 107, comprising, for example, a keyboard and a mouse, and a graphical user interface processor 108. The personal computer 103 includes or is connectable to a display screen 109 for presenting graphical information, and producing sound by means of built-in loudspeakers. FIG. 1 provides only a schematic overview of the components which are relevant to the present invention. Other components which may be required for a proper operation, such as a video and/or audio processor, power supply, BIOS ROM etc., are not shown or can be considered a part of other components. The graphical user interface processor 108 may be a functional module of a software program being executed, and make use of graphical subroutines which are part of an operating system or video processor.

The user control means 107 enable the user to start and terminate computer programs, enter data, make menu selections etc. Many of such computer programs comprise a graphical user interface which is generated by means of the graphical user interface processor 108 and presented on the display screen 109. Such a graphical user interface comprises, inter alia, windows, buttons, scroll-bars and menus enabling the user to control functions of the program. Furthermore, the graphical user interface determines, to a large extent, whether or not the program product has an attractive appearance. The graphical user interface processor 108 is capable of adapting the appearance of program products by applying a specific skin to the graphical user interface. Such a skin alters the look of the graphical user interface by defining a specific background, colors and shapes, and the position and nature of control buttons in the graphical user interface. Alternatively, certain parameters of the currently applied skin, e.g. colors or brightness, may be changed, instead of the complete skin being replaced.

In one embodiment, a skin change is initiated by a skin change command received from the remote server 101 via the network 102. For example, the personal computer 103 may be executing an audio player program product which continuously plays songs received from the remote server 101, for example in the RealAudio™ format. Each song may have an attribute which indicates the genre or other properties of the song. In dependence on such an attribute, the remote server 101 transmits skin change commands so as to change the applied skin in such a way that it optimally matches the currently played song. For example, when playing classical music, a ‘classical looking’ skin will be applied, possibly comprising pictures of the composer or prominent instruments, while pop music may be accompanied by a skin comprising more vivid colors, pictures of pop-stars, or dynamically changing parts. A skin which has not been previously applied is transmitted to the personal computer 103 along with the skin change command and stored in the local storage 106. When the skin is to be applied a next time, for example when it optimally matches a song being played, only the skin change command is transmitted and the corresponding skin is loaded from the local storage 106.

In a further embodiment, the skin change command is generated locally. For example, an audio player program product according to the invention is capable of playing songs stored in the local storage 106 or downloaded from the remote server 101. Each song is associated with a genre indicator which is interpreted by the audio player and associated with a particular skin. When a new song starts playing, a skin associated with the song's genre is loaded and applied to the graphical user interface. Multiple skins may be associated with a particular genre, or multiple genres may be associated with a particular skin. A song may be associated with multiple genres, hence with multiple skins, for example a first part of the song may have a first genre and a second part may have a second genre, causing a skin change at the transition from the first part to the second part.

A skin change may be abrupt or proceed gradually, for example the previous skin may be faded out while the next skin is faded in simultaneously. Different skins may be applied to different parts of the graphical user interface.

In a further embodiment the personal computer 103 may comprise sensors (not shown) which measure ambient factors such as ambient light and/or noise. The output of such sensors can be used to influence the selection of skins or the appearance of a particular skin. For example, in a light and noisy environment, a more vivid skin may be selected than in a more dim and restful situation.

FIG. 2 shows a block diagram of a digital television receiver which forms an embodiment of the apparatus according to the invention. Digital broadcast streams, modulated upon radio frequency (RF) signals, are received from the ether by an antenna 201 or, alternatively, from a cable network. The broadcast streams may be formatted, for example, in accordance with the Digital Video Broadcasting (DVB) standard. A tuner 202 comprises a standard analog RF receiving device which is capable of receiving said RF signals and selecting one of them to be output to a demodulator 203. Which signal the tuner 202 selects is dependent upon control data received from a central processing unit (CPU) 205. A demodulator 203 converts the analog signal into a digital packet stream, based on control signals received from the CPU 205. This packet stream is then output to a demultiplexer 204, which selects packets belonging to a particular program in accordance with control data received from the CPU 205, and decomposes the packet stream into elementary video, audio or data streams.

A video processor 208 decodes the video stream received from the demultiplexer 204 or from the CPU 205. In preferred embodiments of the invention, the video processor 208 is an MPEG-2 decoder. However, any decoder may be used as long as the decoder is compatible with the type of coding used to code the video data. Decoded video data is then transmitted to a display screen 209. An audio processor 206 decodes the audio stream received from the demultiplexer 204. Again, any decoder may be used as long as the decoder is compatible with the type of coding used to code the audio data. Decoded audio data is then transmitted to a loudspeaker system 207.

The demultiplexer 204 outputs the elementary data stream to the CPU 205. The elementary data stream has two types of data: control data and content data. Content refers to, for example, interactive programs; control refers to tables in the multiplex which specify matters like the structure of the multiplex, the (RF) frequencies at which the channels are modulated, and the addresses at which the various content components and the (other) tables in the multiplex can be found. The CPU 205 comprises one or more microprocessors capable of executing program instructions stored in a read-only memory (ROM) 212. These program instructions comprise parts of software modules including, inter alia, a command module 213, an EPG module 214, a user profile module 215 and a graphical user interface module 216. Data processed by said software modules, e.g. DVB-SI data and user profile information, may be stored in a non-volatile memory 211. The command module 213 is capable of controlling functions of the TV-set, like selecting TV channels and controlling picture parameters. A remote control 210 receives user commands, and transmits them to the command module 213 to be processed. The EPG module 214 interprets the DVB-SI data received from the demultiplexer 204 to collect information about the channels (‘services’ in DVB terminology) available in the received broadcast streams and about the programs (‘events’ in DVB terminology) scheduled for those channels. The user profile module 215 monitors the user's behavior, including, for example, channel selections and viewing times per channel and/or program category, and adapts the user profile accordingly. The graphical user interface module 216 generates a graphical user interface on the display screen 209 to convey information to the user and to enable the user to control various functions of the television receiver, such as the EPG and on-screen menus. Such functions may share the same look and feel provided by a consistent graphical user interface. Just as in the embodiment depicted in FIG. 1, the graphical user interface module 216 can make the graphical user interface more appealing by applying attractive skins to it. In the present embodiment the selection of skins is influenced by, inter alia, the user profile. This is particularly advantageous since a user profile is a model of the user's taste and, possibly, mood (dependent on how quickly the user profile adapts in response to user actions), hence factors which are likely to influence the user's appreciation of a skin. Various skins may be stored in the memory 211 or 212 and associated with parameters of the user profile, in particular preferred program categories. Skins may further be provided by the broadcaster or service provider in that skins are encoded in the DVB-SI data. Alternatively or additionally, said broadcaster or service provider may cause the graphical user interface module 216 to change the applied skin by transmitting a suitable skin change command.

Skins may be applied not only to graphical functions of the television receiver, but also to the actual program viewing function. In such case, the main part of the screen is dedicated to show video information, e.g. from a broadcast channel or a video recorder. Another part of the screen may show the applied skin, e.g. as a kind of frame around the video part. If a movie is shown in a letterbox format, the parts of the screen below and above the video part may be used to show the applied skin.

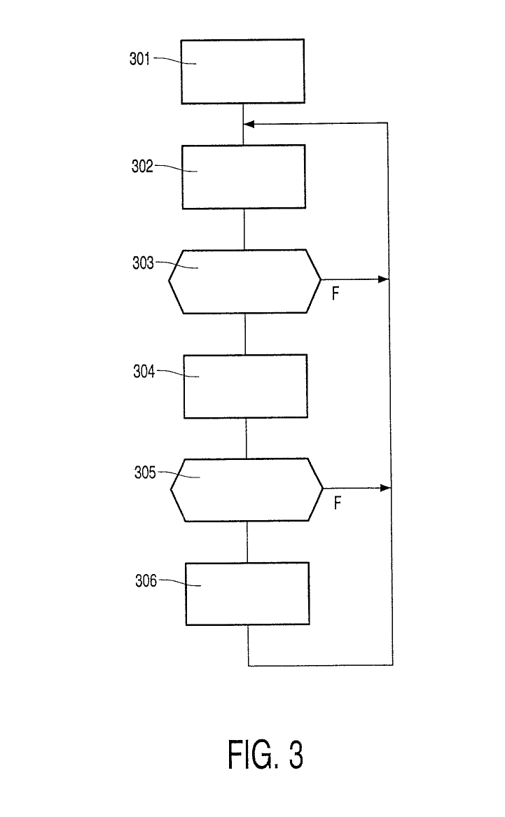

FIG. 3 shows a flow-chart of a simple method of distributing audio and/or video content according to the invention. In an initialization step 301, some default skins are transmitted to subscribers, and information relating to user profiles and locally stored skins may be returned. After the initialization step 301, a loop is started corresponding to the transmission of a sequence of programs, e.g. TV programs or audio tracks. A program is transmitted in a step 302 and, after each program, it is checked in a step 303 whether the next program is of a different genre. If not, the loop proceeds normally, and otherwise a skin change command is transmitted in a step 304. Subsequently, it is checked in a step 305 whether the skin corresponding to the genre of the next program is already available at the subscriber's side. This may be determined by requesting information via a return channel, or by recording which skins have already been transmitted and how long ago that was, while allowance may be made for the (minimum) amount of local storage at the subscriber's side. If transmission of the skin s not required, the loop proceeds normally, and otherwise the skin is transmitted to be stored at the subscriber's side and applied to the graphical user interface of the subscriber's receiver apparatus.

Although the invention has been described with reference to particular illustrative embodiments, variants and modifications are possible within the scope of the inventive concept. Thus, for example, instead of a completely different skin being selected, only one or more aspects of a skin, e.g. color and/or brightness, may be changed. Skins may be static, or may have dynamic, e.g. animated, parts. Fading techniques, known per se, may be used to make a skin change proceed gradually. Skins may also be applied in small portable devices such as MP3 players, mobile phones, remote controls etc. In a mobile phone, the applied skin may be dependent on the identity of the person called or calling. A caller may, for example, transmit a personal skin to the phone of the called person. Alternatively or additionally, the skin may change in response to an incoming call from a known person who has earlier been associated with a particular skin.

In summary, the invention relates to a method and apparatus for adapting a graphical user interface. A skin is applied to the graphical user interface so as to influence its look and feel, in response to an event which does not originate from a user request to change the currently applied skin. Such an event may be a change of a category of presented information, a command received from a remote server or a change of a user profile. Skins thus change dynamically without requiring an explicit user request. The use of the verb ‘to comprise’ does not exclude the presence of any elements or steps other than those defined in a claim. The invention can be implemented by means of hardware comprising several distinct elements, and by means of a suitably programmed computer. In the device claim enumerating several means, several of these means can be embodied by one and the same item of hardware.

A ‘computer program’ is to be understood to mean any software product stored on a computer-readable medium, such as a floppy-disk, downloadable via a network, such as the Internet, or marketable in any other manner.

1. An apparatus comprising presentation means for presenting a graphical user interface and skin means for applying a skin to the graphical user interface so as to influence the look of the graphical user interface, characterized in that the skin means are adapted to change a currently applied skin in response to an event not originating from a user request to change the currently applied skin.

2. An apparatus as defined in claim 1, characterized in that the apparatus further comprises receiving means for receiving information from a remote server, said event comprising the reception of a skin change command from the remote server.

3. An apparatus as defined in claim 2, characterized in that the apparatus further comprises storage means for storing a plurality of skins, the skin change command including an identification of a respective one of the plurality of skins, the skin means being adapted to apply said respective skin to the graphical user interface in response to said skin change command.

4. An apparatus as defined in claim 2, characterized in that the skin change command including a further skin, the skin means being adapted to apply said further skin to the graphical user interface.

5. An apparatus as defined in any one of claims 1 to 4, characterized in that the presentation means are capable of presenting further information, the event comprising a change of a parameter of said further information.

6. An apparatus as defined in claim 5, characterized in that said further information comprises audio and/or video content, said parameter representing a category of said content.

7. An apparatus as defined in any one of claims 1 to 6, characterized in that the apparatus further comprises user profile means for maintaining a user profile, said event comprising a change of said user profile.

8. A computer program product for causing, when executed on a computing device, said computing device to constitute an apparatus as defined in any one of claims 1 to 7.

9. A method of transmitting information to an apparatus, the apparatus having presentation means for presenting a graphical user interface and skin means for applying a skin to the graphical user interface so as to influence the look of the graphical user interface, characterized in that the information comprises a skin change command to the apparatus for changing a currently applied skin.

10. A method as defined in claim 9, characterized in that said skin change command includes an identity of a respective skin stored in storage means of the apparatus, for controlling the skin means so as to apply said respective skin to the graphical user interface.

11. A method as defined in claim 9, characterized in that said skin change command includes a further skin for controlling the skin means so as to apply said further skin to the graphical user interface.

12. A method of distributing audio and/or video content as a method as defined in any one of claims 9 to 11.
